(19) United States
(12) Patent Application Publication
(10) Pub. No.: US 2017/0232506 A1
(43) Pub. Date: Aug. 17, 2017

(54) DIE CAST SYSTEM WITH CERAMIC CASTING MOLD FOR FORMING A COMPONENT USABLE IN A GAS TURBINE ENGINE

(71) Applicant: Siemens Aktiengesellschaft, München (DE)

(72) Inventor: Ching-Pang Lee, Cincinnati, OH (US)

(73) Assignee: Siemens Aktiengesellschaft, Munchen (DE)

(21) Appl. No.: 15/515,339

(22) PCT Filed: Oct. 15, 2014
(86) PCT No.: PCT/US2014/060565

§ 371 Date: Mar. 29, 2017

(51) Int. Cl. B22D 25/02; B33Y 10/00; F01D 5/18; B22C 1/00; B22C 9/24; B22D 29/00; B28B 1/00; B33Y 80/00

(52) U.S. Cl. CPC B22D 25/02; B28B 1/001; B33Y 10/00; B33Y 80/00; B22C 1/00; B22C 9/24; B22D 29/001; F01D 5/187; F05D 2230/211; F05D 2230/22; F05D 2300/17; F05D 2300/20

(57) ABSTRACT

A die cast system in which an external shell and an internal core usable to form a component of a gas turbine engine are formed together is disclosed. In at least one embodiment, the external shell and internal core may be formed from at the same time via a selective laser melting process, thus eliminating the need for using the conventional lost-wax casting system. In at least one embodiment, the external shell and internal core may be formed a ceramic material that may support receiving molten metal to form a turbine component. Once formed, the external shell and internal core may be removed to reveal the turbine component.

### FIELD OF THE INVENTION

This invention is directed generally to die cast systems, and more particularly to manufacturing methods for turbine airfoils usable in turbine engines.

### BACKGROUND

Turbine blade airfoils typically have internal cooling systems formed from a plurality of cooling channels, as shown in FIGS. 2 and 3. To form these cooling channels inside of a blade, a casting mold is often used and includes an internal ceramic core and external ceramic shell. The ceramic core, as shown in FIG. 1, is manufactured to include detail features on the core die surface in order to form efficient cooling devices inside the blade casting. The core dies typically used to form cores are most often formed from hard steel, which are expensive to manufacture. The core die surfaces are typically in direct contact with the ceramic core material during the high pressure injection process. The core die will wear out after sufficient injections and lead to non-conforming casting. To maintain accurate casting dimensions, the core die needs to be reworked or replaced when a core die becomes worn, which is an expensive endeavor. Even a small improvement in a design on an internal surface requires that a completely new die be made. Thus, a need exists for a more robust, less expensive system.

### SUMMARY OF THE INVENTION

A die cast system in which an external shell and an internal core usable to form a component of a gas turbine engine are formed together is disclosed. In at least one embodiment, the external shell and internal core may be formed from at the same time via a selective laser melting process, thus eliminating the need for using the conventional lost-wax casting system. In at least one embodiment, the external shell and internal core may be formed a ceramic material that may support receiving molten metal to form a turbine component. Once formed, the external shell and internal core may be removed to reveal the turbine component.

In at least one embodiment, the die cast system may include one or more external shells having an inner surface configured to define an outer surface of a turbine engine component. The die cast system may also include one or more internal cores formed by a same process as used to form the external shell, whereby the internal core is formed within the external shell while the external shell is formed.

The internal core may include an outer surface offset radially inward from the inner surface of the external shell, whereby the outer surface may be used to at least define an inner surface of an outer wall formed by the die cast system. In at least one embodiment, the external shell and the internal core may be both formed via a selective laser melting system. The external shell and the internal core may be both formed from a ceramic material. The inner surface of the external shell may be configured to form an airfoil usable within a gas turbine engine, whereby the airfoil may include a pressure side on a first side, a suction side on a second side that is on an opposite side from the first side, a leading edge and a trailing edge. The internal core may be formed from one or more core bodies having the outer surfaces used to at least define the inner surface of the outer wall formed by the die cast system and defining an internal cooling system of the turbine engine component. The internal core may be formed from a plurality of internal core bodies that are offset from each other and configured to form channels of the internal cooling system within the turbine engine component. The plurality of internal core bodies may be offset from each other to produce cavities between the internal core bodies such that internal ribs are formed within the turbine engine component by the die cast system. The die cast system may include an external support shell surrounding the external shell. The external support shell may be formed from a same material as the at least one external shell.

A method of forming a turbine component may include forming one or more external shells and one or more internal cores via a same process, whereby the external shell may have an inner surface configured to define an outer surface of a turbine engine component and the internal core is formed within the external shell while the external shell is being formed. The internal core may also include an outer surface offset radially inward from the inner surface of the external shell, whereby the outer surface is used to at least define an inner surface of an outer wall formed by the die cast system. The method may also include injecting a molten alloy material into at least one inner cavity formed between the external shell and the internal core. The method may also include removing the at least one external shell and removing the at least one internal shell. Forming the external shell and the internal core via a same process may include forming the external shell and the internal core via a selective laser melting system.

The method may also include forming an external support shell surrounding the external shell. Forming the external support shell surrounding the external shell may include forming the external support shell from a same material used to form the external shell. The method may also include removing the external support shell surrounding the external shell after injecting a molten alloy material into one or more inner cavities formed between the external shell and the internal core. Forming the external shell and the internal core via a same process may include forming the external shell and the internal core from a ceramic material. The external shell and the internal core may include forming the external shell and the internal core, whereby the inner surface of the external shell may be configured to form an airfoil usable within a gas turbine engine, whereby the airfoil may include a pressure side on a first side, a suction side on a second side that is on an opposite side from the first side, a leading edge and a trailing edge. Forming the external shell and the internal core may include forming the external shell and the internal core, whereby the internal core may be formed from at least one core body having the outer surfaces used to at least define the inner surface of the outer wall formed by the die cast system and defining an internal cooling system of the turbine engine component.

Forming the external shell and the internal core may include forming external shell and the internal core, whereby the internal core may be formed from a plurality of internal core bodies that are offset from each other and configured to form channels of the internal cooling system within the turbine engine component. Forming the external shell and the internal core may include forming the external shell and the internal core, wherein the plurality of internal core bodies may be offset from each other to produce cavities between the internal core bodies such that internal ribs are formed within the turbine engine component by the die cast system.

An advantage of the die cast system is that external shell and internal core used to form a cavity to receive molten metal may be formed via a selective laser melting process which is less time consuming and more accurate than conventional lost-wax casting system.

Another advantage of the die cast system is that the die cast system may readily accept changes to the design of the turbine component being produced via the die cast system by using the selective laser melting process to create an external shell and internal core with the design changes.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a conventionally formed core.

FIG. 2 is a cross-sectional view of two adjacent conventional turbine airfoils.

FIG. 3 is a cross-sectional view of a conventional turbine airfoil with an internal cooling system.

FIG. 4 is a cross-sectional view of formation of an external shell and an internal core of the die cast system.

FIG. 5 is a cross-sectional view of the external shell and the internal core of the die cast system with molten metal poured in cavities between the external shell and the internal core.

FIG. 6 is a cross-sectional view of a turbine component, such as an airfoil, with the external shell removed and the internal core in place.

FIG. 7 is a cross-sectional view of a turbine component, such as an airfoil, with the external shell and internal core removed.

FIG. 8 is a cross-sectional view of formation of an external shell and an internal core of the die cast system.

FIG. 9 is a cross-sectional view of an external shell and an internal core of the die cast system with an external support shell positioned around the external shell.

FIG. 10 is a cross-sectional view of the external shell and the internal core of the die cast system with molten metal poured in cavities between the external shell and the internal core.

FIG. 11 is a cross-sectional view of a turbine component, such as an airfoil, with the external shell removed and the internal core in place.

FIG. 12 is a cross-sectional view of a turbine component, such as an airfoil, with the external shell and internal core removed.

FIG. 13 is a perspective view of a turbine airfoil formed with the die cast system of FIGS. 4-12 and via the method of using the system shown in FIGS. 17 and 18.

FIG. 14 is a cross-sectional view of the turbine airfoil taken along section line 14-14 in FIG. 13.

FIG. 15 is a perspective view of a suction side of the internal core.

FIG. 16 is a perspective view of a pressure side of the internal core.

FIG. 17 is a flow chart of a method of forming a casting component, such as, but not limited to, an airfoil from cast metal.

FIG. 18 is a flow chart of another embodiment of a method of forming a casting component, such as, but not limited to, an airfoil from cast metal.

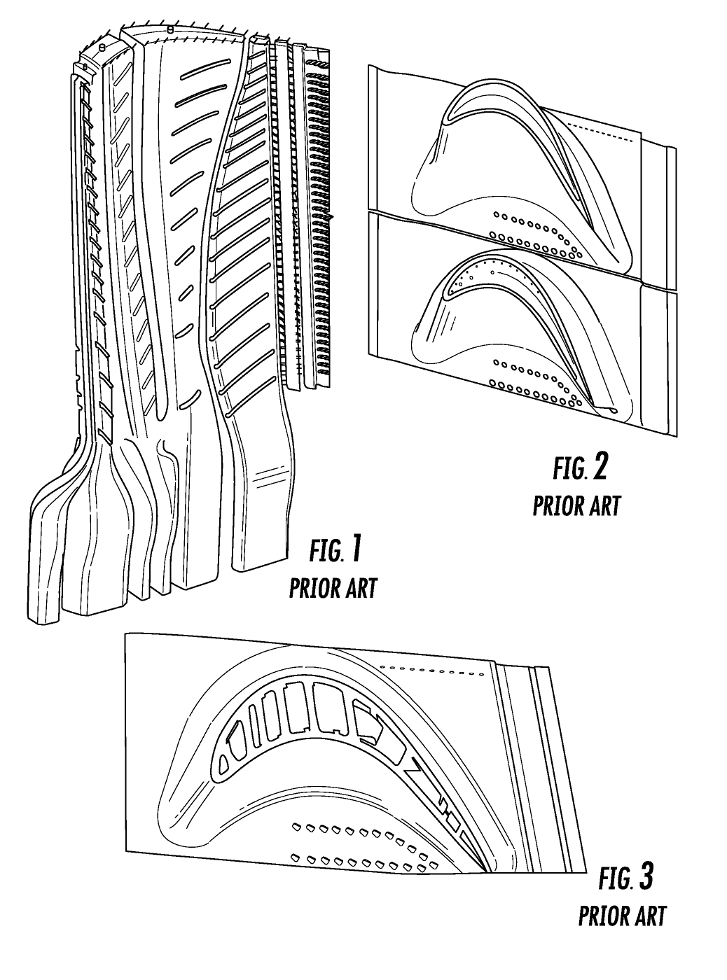

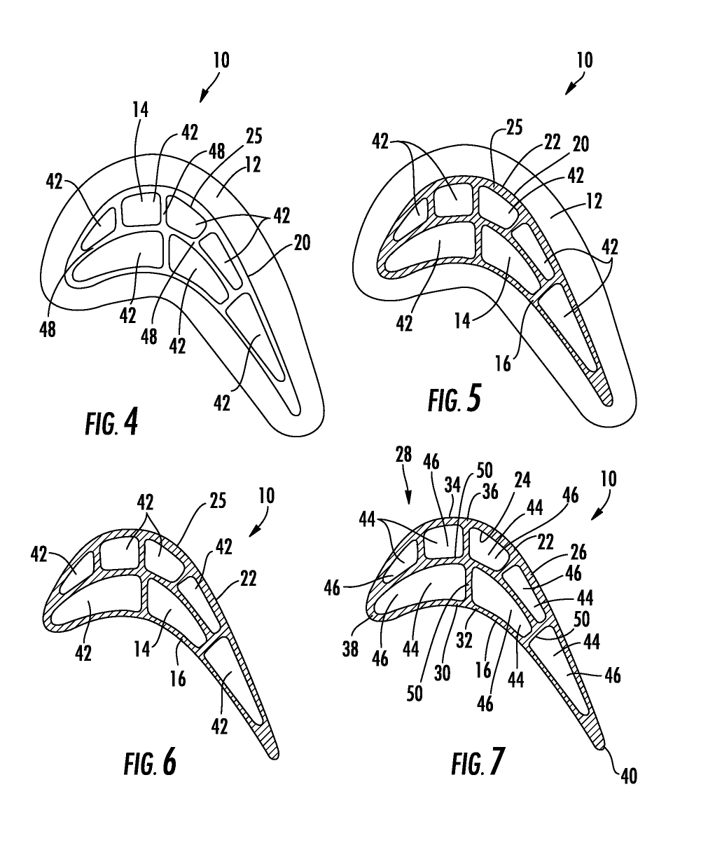

### DETAILED DESCRIPTION OF THE INVENTION

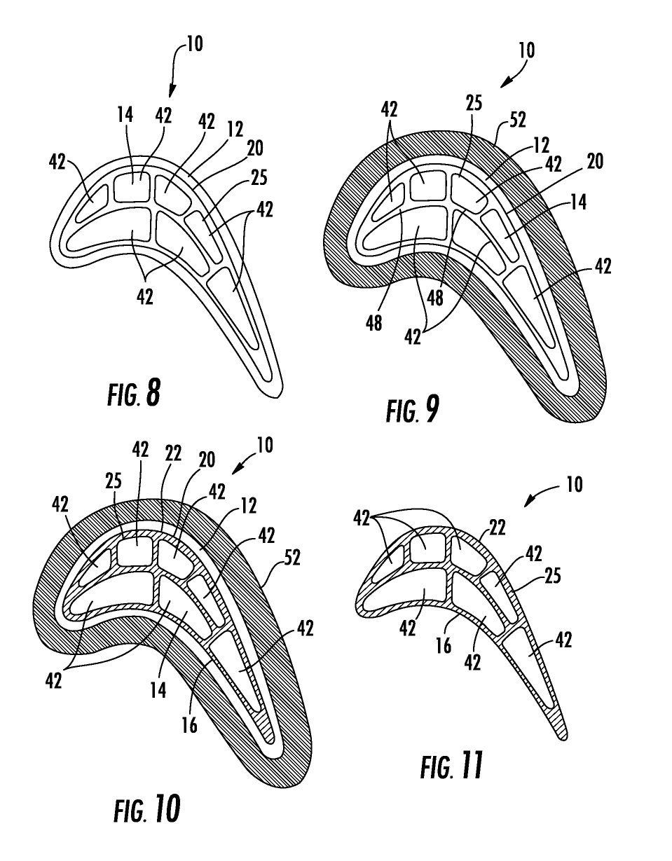

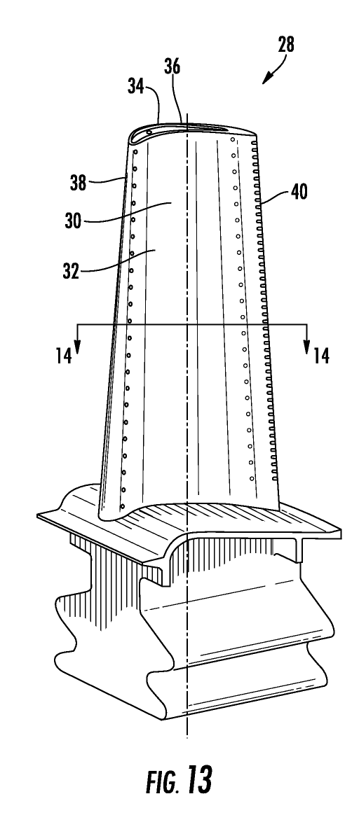

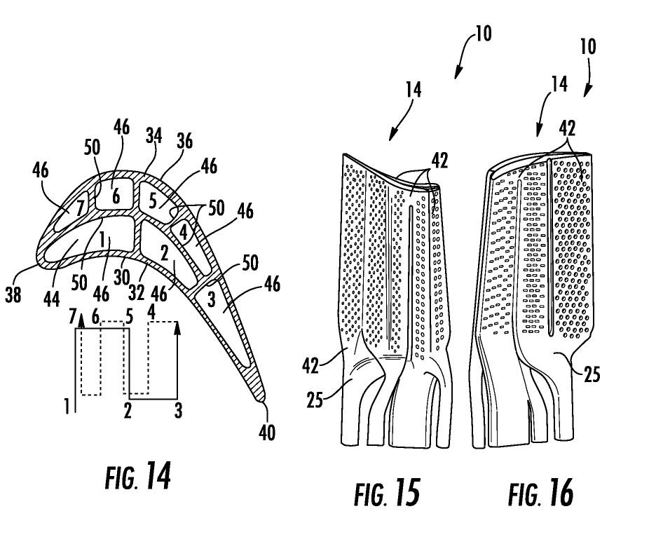

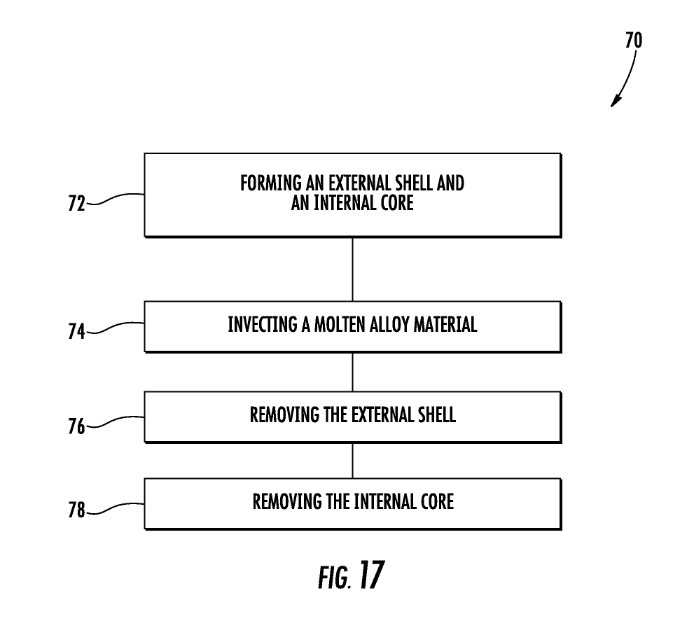

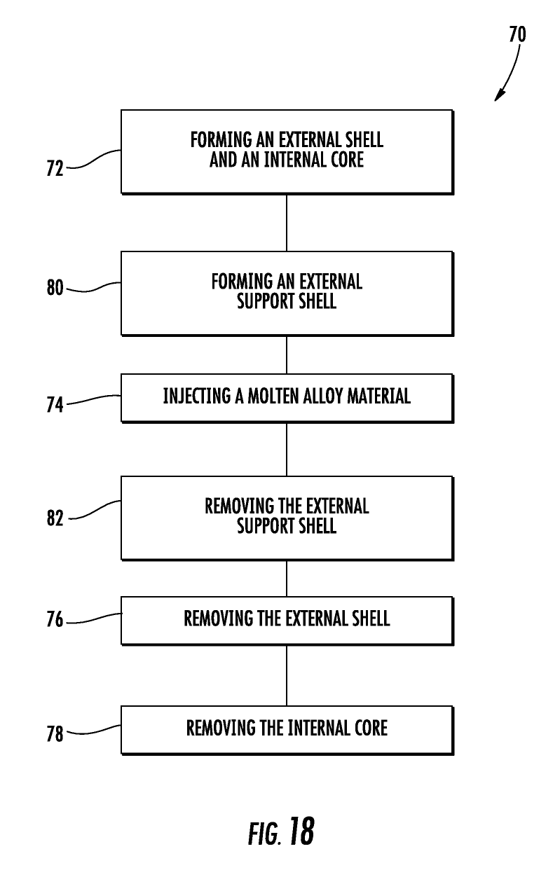

As shown in FIGS. 4-18, a die cast system 10 in which an external shell 12 and an internal core 14 usable to form a component 16 of a gas turbine engine are formed together is disclosed. In at least one embodiment, the external shell 12 and internal core 14 may be formed from at the same time via a selective laser melting process, thus eliminating the need for using the conventional lost-wax casting system. In at least one embodiment, the external shell 12 and internal core 14 may be formed a ceramic material that may support receiving molten metal to form a turbine component 16. Once formed, the external shell 12 and internal core 14 may be removed to reveal the turbine component 16.

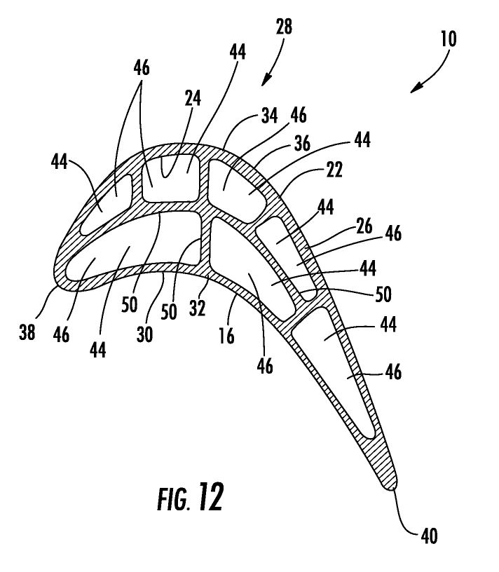

In at least one embodiment, as shown in FIGS. 4, 5 and 8-10, the die cast system 10 may be formed from one or more external shells 12 having an inner surface 20 configured to define an outer surface 22 of a turbine engine component 16. The internal core 14 may be formed by a same process as used to form the external shell 12. The internal core 14 may be formed within the external shell 12 while the external shell 12 is formed. The internal core 14 may include an outer surface 25 offset radially inward from the inner surface 20 of the external shell 12. The outer surface 25 may be used to at least define an inner surface 24 of an outer wall 26 formed by the die cast system 10, as shown in FIGS. 7 and 12. In at least one embodiment, the external shell 12 and the internal core 14 may both be formed via a selective laser melting system, with a material such as, but not limited to, a ceramic material. The selective laser melting system may begin by slicing a three dimensional computer aided drawing (CAD) model into a number of finite layers. For each sliced layer, a laser scan path may be calculated which defines both the boundary contour and some form of fill sequence. Each layer may then be sequentially recreated by depositing powder layers, one on top of the other, and melting their surface by scanning a laser beam. In at least one embodiment, the inner surface 20 of the external shell 12 may be configured to form an airfoil 28 usable within a gas turbine engine. The airfoil 28 may include a pressure side 30 on a first side 32, a suction side 34 on a second side 36 that is on an opposite side from the first side 32, a leading edge 38 and a trailing edge 40.

The internal core 14 may be formed from one or more core bodies 42, as shown in FIGS. 4-6, 8-11, 15 and 16, having the outer surfaces 25 used to at least define the inner surface 24 of the outer wall 26 formed by the die cast system 10 and defining an internal cooling system 44 of the turbine engine component 16. In at least one embodiment, the internal core 14 may be formed from a plurality of internal core bodies 42 that are offset from each other and configured to form channels 46 of the internal cooling system 44 within the turbine engine component 16, as shown in FIG. 14. As shown in FIGS. 4 and 8, the plurality of internal core bodies 42 are offset from each other to produce cavities 48 between the internal core bodies 42 such that internal ribs 50 are formed within the turbine engine component 16 by the die cast system 10. In at least one embodiment, the external shell 12 may be made thinner, and the external shell 12 may be supported via an external support shell 52 surrounding the external shell 12. The external support shell 52 may be formed from a same material as the external shell 12.

As shown in FIGS. 17 and 18, a method 70 of forming a turbine component may include at 72 forming one or more external shells 12 and one or more internal cores 14 via a same process. The external shell 12 may have an inner surface 20 configured to define an outer surface 22 of a turbine engine component 16 and the internal core 14 may be formed within the external shell 12 while the external shell 12 is being formed. The internal core 14 may include an outer surface 25 offset radially inward from the inner surface 20 of the external shell 12, whereby the outer surface 25 may be used to at least define an inner surface 24 of an outer wall 26 formed by the die cast system 10. The method 70 may also include at 74 injecting a molten alloy material into one or more inner cavities 48 formed between the external shell 12 and the internal core 14. The method 70 may include at 76 removing the external shell 12 and at 78 removing the internal shell 14.

Forming the external shell 12 and the internal core 14 via a same process may include at 72 forming the external shell 12 and the internal core 14 via a selective laser melting system. The method 70, as shown in FIG. 18 and in FIGS. 8-12, may also include at 80 forming an external support shell 52 surrounding the external shell 12. Forming the external support shell 52 surrounding the external shell 12 at 80 may include forming the external support shell 52 from a same material used to form the external shell 12. The method 70 may also include at 82 removing the external support shell surrounding the external shell 12 after injecting a molten alloy material into one or more inner cavities 48 formed between the external shell 12 and the internal core 14. Forming the external shell 12 and the internal core 14 via a same process may include forming the external shell 12 and the internal core 14 from a ceramic material. Forming the external shell 12 and the internal core 14 may include forming the external shell 12 and the internal core 14 wherein the inner surface 20 of the external shell 12 is configured to form an airfoil 28 usable within a gas turbine engine, wherein the airfoil 28 includes a pressure side 30 on a first side, a suction side 34 on a second side that is on an opposite side from the first side, a leading edge 38 and a trailing edge 40.

Forming the external shell 12 and the internal core 14 may include forming the external shell 12 and the internal core 14, wherein the internal core 14 is formed from one or more core bodies 42 having the outer surfaces 25 used to at least define the inner surface 24 of the outer wall 26 formed by the die cast system 10 and defining an internal cooling system 44 of the turbine engine component 16. Forming the external shell 12 and the internal core 14 may include forming the external shell 12 and the internal core 14, wherein the internal core 14 may be formed from a plurality of internal core bodies 42 that are offset from each other and configured to form channels 46 of the internal cooling system 44 within the turbine engine component 16. Forming the external shell 12 and the internal core 14 may include forming the external shell 12 and the internal core 14, wherein the plurality of internal core bodies 42 may be offset from each other to produce cavities 48 between the internal core bodies 42 such that internal ribs 50 are formed within the turbine engine component 16 by the die cast system 10.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1-9. (canceled)

10. A process for forming a turbine component comprising:
forming an external shell having an inner surface and forming a plurality of internal core bodies spaced inboard from the inner surface, wherein the forming of the external shell and the forming of the internal core bodies define a cavity between the inner surface and the internal core bodies corresponding to a desired dimension of an outer wall for the component and also cavities between adjacent internal core bodies corresponding to desired dimensions for internal ribs for the component, and wherein the forming of the external shell and the forming of the internal core bodies are done simultaneously on a layer by layer basis via a selective laser melting process;
injecting a molten alloy material into the plurality of cavities between the inner surface and the internal core bodies, and between adjacent internal core bodies; and
removing the external shell and the internal core bodies to reveal the turbine component formed from the alloy material, the turbine component comprising the outer wall, the internals ribs, and radially extending hollow cooling channels inboard of the outer wall in locations vacated by the removed internal core bodies.

11. The process of claim 10, wherein the selective laser melting process comprises repeatedly depositing a layer of a ceramic powder material and melting the ceramic powder material via a laser beam.

12. The process of claim 10, wherein the component formed by the process comprises an airfoil having a pressure side on a first side, a suction side on a second side opposite the first side defined between a leading edge and a trailing edge, the airfoil having the plurality of radially extending cooling channels formed therein.

13. The process of claim 10, further comprising:
forming an external support shell about the external shell; and
after the injecting of the molten alloy material, removing the external support shell.
